(19) United States
(12) Patent Application Publication
(10) Pub. No.: US 2026/0291959 A1
(43) Pub. Date: Sep. 24, 2026

(54) METHOD AND SYSTEM FOR NETWORK THREAT ACTOR DETECTION

(71) Applicant: Royal Bank of Canada, Toronto (CA)

(72) Inventors: Connor Sheere, Toronto (CA); Nariman Mammadli, Toronto (CA); Harrison Holmes, Toronto (CA)

(21) Appl. No.: 19/573,565

(22) Filed: Mar. 20, 2026

Related U.S. Application Data
(60) Provisional application No. 63/775,146, filed on Mar. 20, 2025.

(51) Int. Cl. H04L 9/40

(52) U.S. Cl. CPC H04L 63/1416

(57) ABSTRACT

Methods, systems, and techniques for network threat actor detection. At least one data log storing network usage statistics of services available on a network is retrieved. Based on those statistics, (i) an expected usage rate by authorized network users of the services, and (ii) an observed usage rate of the services from at least one of the users are determined. The difference between the expected and observed usage rates is determined, and if that difference satisfies a threat threshold, the at least one of the users is flagged as at least one potential threat actor.

### CROSS-REFERENCE TO RELATED APPLICATION

The present application claims priority to U.S. provisional patent application No. 63/775,146, filed on Mar. 20, 2025, and entitled “Method and System for Network Threat Actor Detection”, the entirety of which is hereby incorporated by reference.

### TECHNICAL FIELD

The present disclosure is directed at methods, systems, and techniques for network threat actor detection. More particularly, the present disclosure is directed at determining that a network user is a potential threat actor who is attempting to fraudulently obtain the network credentials of one of the network's users and thereby gain illicit access to the network.

### BACKGROUND

In a typical enterprise computer network, servers that are part of the network are used to offer a variety of different services to a variety of different users. Each of the services may by default require each user to log into that service using service-specific access credentials prior to permitting the user to use that service. While single sign-on protocols can be used to mitigate this inconvenience to users, adopting their convenience involves exposing the network to any security flaws inherent in those protocols.

### SUMMARY

According to a first aspect, there is provided a network threat actor detection method comprising: retrieving at least one data log comprising network usage statistics of services available on a network; determining, based on the network usage statistics, (i) an expected usage rate by authorized network users of the services, and (ii) an observed usage rate of the services from at least one of the users; determining that the expected usage rate and the observed usage rate differ by at least a threat threshold; and in response to the determining that the expected usage rate and the observed usage rate differ by at least the threat threshold, flagging the at least one of the users as at least one potential threat actor.

The expected usage rate may be a historical usage rate of the services for all users over a time period determined from the network usage statistics; and the observed usage rate may comprise at least one service used by the at least one of the users from the services.

The determining that the expected usage rate and the observed usage rate differ by at least the threat threshold may comprise determining an observed usage likelihood based on the observed usage rate and a reference usage likelihood for evaluating the observed usage likelihood to determine that the at least one of the users is the at least one potential threat actor.

The determining that the expected usage rate and the observed usage rate differ by at least the threat threshold may comprise determining a Bayesian probability for the at least one service being used by a threat actor based on the observed usage likelihood and the reference usage likelihood; and determining that the expected usage rate and the observed usage rate differ by at least the threat threshold by comparing the Bayesian probability to a threshold probability.

The historical usage rate may comprise a number of distinct users for each of the services.

The observed usage likelihood may be a first predicted probability, calculated as a product of expected usage probabilities for the at least one service, each expected usage probability corresponding to the number of distinct users for a respective service and a total number of distinct users; and the reference usage likelihood may be a second predicted probability, calculated as a product of threat actor usage probabilities for the at least one service, each threat actor usage probability corresponding to a uniform probability across the services.

The observed usage likelihood may be a first predicted probability, calculated as a product of expected usage probabilities for the at least one service, each expected usage probability corresponding to a number of requests made by all of the users for a respective service and a total number of requests made by all of the users for the services; and the reference usage likelihood may be a second predicted probability, calculated as a product of threat actor usage probabilities for the at least one service, each threat actor usage probability corresponding to a uniform probability across the services.

The determining of the Bayesian probability may be further based on a first prior probability of the services being used by a benign user and a second prior probability of the services being used by the threat actor.

The first and second prior probabilities or a ratio thereof may be tunable hyperparameters.

The first and second prior probabilities may vary based on a type of the at least one of the users or a group to which the at least one of the users belongs.

The determining of the threat threshold may comprise determining a Kullback-Leibler entropy value for the at least one service being used by a threat actor based on the observed usage likelihood and the reference usage likelihood; and determining that the expected usage rate and the observed usage rate differ by at least the threat threshold by comparing the Kullback-Leibler entropy value to a threshold entropy value.

The historical usage rate may comprise a number of requests made by all of the users for each of the services; and the observed usage rate may comprise a number of requests made by the at least one of the users for each of the at least one service.

The observed usage likelihood may be a first set of usage distributions for usage of the at least one service by the at least one of the users; and the reference usage likelihood may be a second set of usage distributions for usage of the at least one service by all of the users.

Each probability in the first set of usage distributions may correspond to the number of requests made by the at least one of the users for a respective service and a total number of requests made by the at least one of the users; and each probability in the second set of usage distributions may correspond to the number of requests made by all of the users and a total number of requests made by all of the users.

The at least one of the users may belong to a group of users; and the expected usage rate may be a historical usage rate of a selection of the services for the group of users over the time period determined from the network usage statistics.

The at least one data log may comprise at least one audit log generated by at least one server providing the services.

The flagging may comprise storing on non-volatile storage a file identifying the at least one of the users as the at least one potential threat actor.

The method may further comprise preventing the at least one of the users from accessing the services.

According to another aspect, there is provided a network threat actor detection system comprising at least one processing unit configured to: retrieve at least one data log comprising network usage statistics of services available on a network; determine, based on the network usage statistics, (i) an expected usage rate by authorized network users of the services, and (ii) an observed usage rate of the services from at least one of the users; determine whether the expected usage rate and the observed usage rate differ by at least a threat threshold; and when the expected usage rate and the observed usage rate are determined to differ by at least the threat threshold, flag the at least one of the users as at least one potential threat actor.

A non-transitory computer-readable medium having stored thereon computer program code that is executable by at least one processor and that, when executed by the at least one processor, causes the at least one processor to perform a network threat actor detection method comprising: retrieving at least one data log comprising network usage statistics of services available on a network; determining, based on the network usage statistics, (i) an expected usage rate by authorized network users of the services, and (ii) an observed usage rate of the services from at least one of the users; determining whether the expected usage rate and the observed usage rate differ by at least a threat threshold; and when the expected usage rate and the observed usage rate are determined to differ by at least the threat threshold, flagging the at least one of the users as at least one potential threat actor.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 depicts a network that comprises a system for network threat actor detection, according to an example embodiment.

FIG. 2A depicts an example single sign-on authentication procedure performed in accordance with the Kerberos™ protocol, according to the prior art.

FIG. 2B depicts an example attempt at network infiltration of the single sign-on authentication procedure of FIG. 2A, according to the prior art.

FIG. 3 depicts an example computer system used to implement the various computing devices depicted in FIGS. 1, 2A, and 2B, according to an example embodiment.

FIG. 4 depicts an example method for network threat actor detection, according to an example embodiment.

FIGS. 5A and 5B depict example expected (FIG. 5A) and observed (FIG. 5B) service logins used to determine service usage rates in respect of a network intrusion attempt, according to an example embodiment.

### DETAILED DESCRIPTION

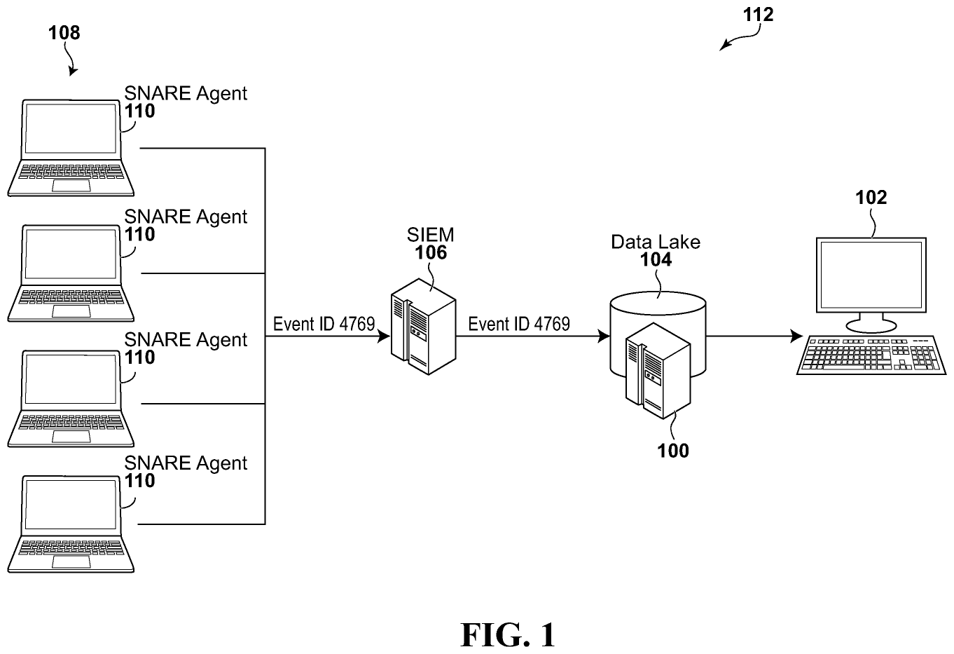

FIG. 1 depicts a network 112 that comprises a system 100 for threat actor detection, according to an example embodiment. The network 112 comprises a client 102 comprising a computer terminal; a data lake 104, communicatively coupled to the client 102, and comprising the system 100 for network threat actor detection; a security information and event management (SIEM) system 106, communicatively coupled to the data lake 104; and a server cluster 108, communicatively coupled to the SIEM system 106, and which comprises audit log agents 110.

The audit log agents 110 may comprise, for example, System iNtrusion Analysis and Reporting Environment (SNARE) agents, which collect logs of data representative of user authentication attempts and security events (e.g., unauthorized access attempts), for example. These logs may comprise, for example, Microsoft Windows™ event logs or syslogs for Unix™ or Linux™-based systems. The audit log agents 110 forward these logs to the SIEM system 106, which aggregates the logs and analyzes the aggregated logs to identify security-related incidents.

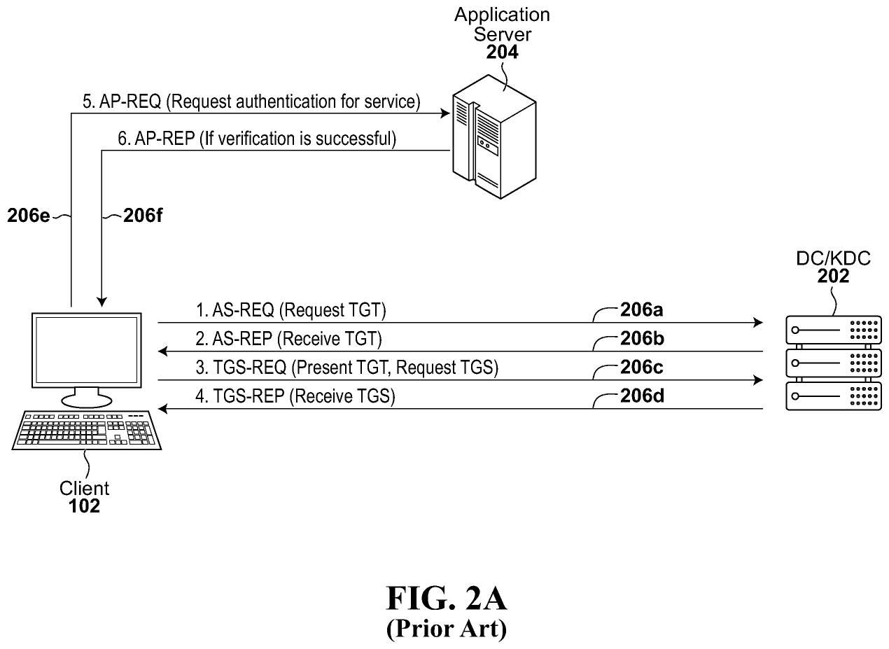

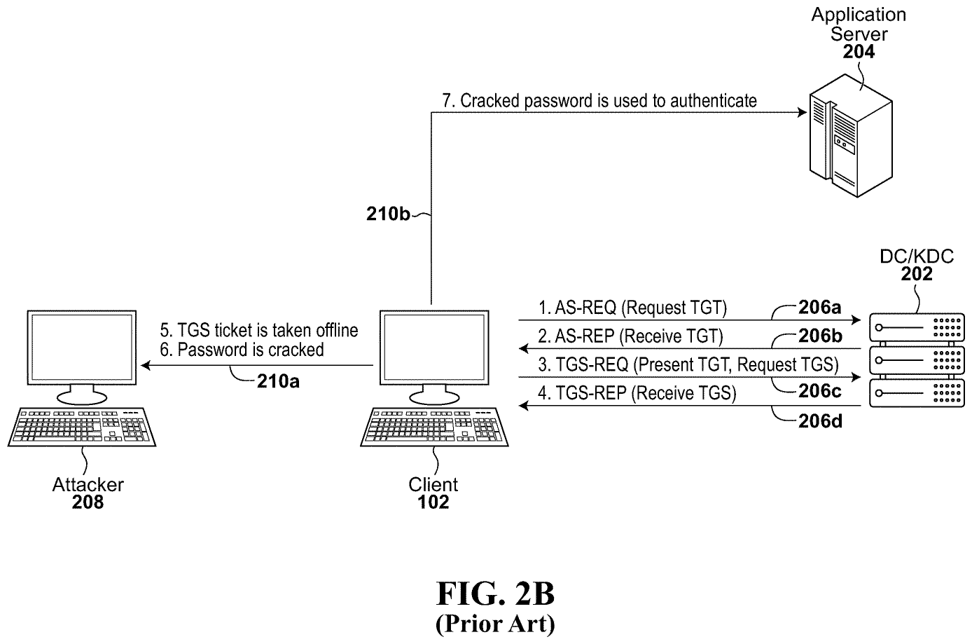

During typical operation, the server cluster 108 may provide various types of services to the client 102, each of which requires the client 102 to somehow authenticate a user of the client 102 to the service prior to being allowed to use the service. One way in which authentication may be done by the network 112 is to implement some type of single sign-on (SSO) functionality such that the user may authenticate themselves once, and through that single authentication gain access to multiple services for a period of time. As discussed further below, and as depicted in respect of FIGS. 2A and 2B, a common way to provide this SSO functionality is to use Kerberos™ authentication.

FIG. 2A depicts an example authentication performed in the context of Kerberos™ authentication. FIG. 2A depicts the client 102 and two different groups of at least one server that comprise part of the server cluster 108: a first group of at least one server that acts as a key distribution center (KDC) 202, and a second group of at least one server that acts as a service server 204. As described further below, the KDC 202 provides authentication services to the client 102, which then allows the client 102 to access any one or more services provided by one or more service servers 204.

Kerberos™ authentication in the context of FIG. 2A occurs generally as follows:
1. Using a first message 206a, the client 102 sends an authentication request to the KDC 202, which comprises an authentication server. The first message 206a is encrypted using the user's password. The authentication server, which has the user's password stored, receives and decrypts the first message 206a using the stored password.
2. In response to the first message 206a, the authentication server generates a ticket-granting ticket (TGT) and encrypts it using a secret key of a ticket-granting server (TGS), which also comprises part of the KDC 202. The encrypted TGT is sent to the client 102 as a second message 206b.
3. When the user wishes to access the service, it generates and sends a third message 206c to the TGS. The third message 206c comprises the encrypted TGT, and also comprises an identifier of the service. On receipt of the message, the TGS decrypts the TGT and sends as a fourth message 206d a service ticket encrypted using the service's secret key.
4. In order to access the service, the client sends the encrypted service ticket as a fifth message 206e to the service server 204. The service server 204 decrypts the fifth message 206e, and assuming verification is successful acknowledges this as a sixth message 206f and subsequently provides the service to the client 102.

FIG. 2B shows an example of how a threat actor 208 may infiltrate the Kerberos™ authentication of FIG. 2A. In FIG. 2B, the first through fourth messages 206a-d are exchanged between the client 102 and the KDC 202 as described above in respect of FIG. 2A. Following receipt of the service ticket as part of the fourth message 206d, the threat actor 208 obtains access to the client 102 and transfers a copy of the service ticket offline (action 210a). Using brute force means, for example, the threat actor 208 cracks the encryption of the service ticket offline to determine the service account's password. The threat actor 208 is then able to directly log into the service server 204 (message 210b) using the hacked service account password, thereby granting the threat actor 208 unfettered access to the network.

In the context of the Kerberos™ network, the type of attack described in respect of FIG. 2B is referred to as “Kerberoasting”. This is a post-exploitation attack technique that leverages a weakness in the Kerberos™ SSO protocol, which is that any registered user can request authentication to any registered service, even if that user does not have access to that service. In this way, a compromised user is able to enumerate the services offered by the server cluster 108 and collect the associated password hashes for offline cracking. Once cracked, the threat actor can return to the network 112 environment and use the cracked, valid password(s) for lateral movement or privilege escalation.

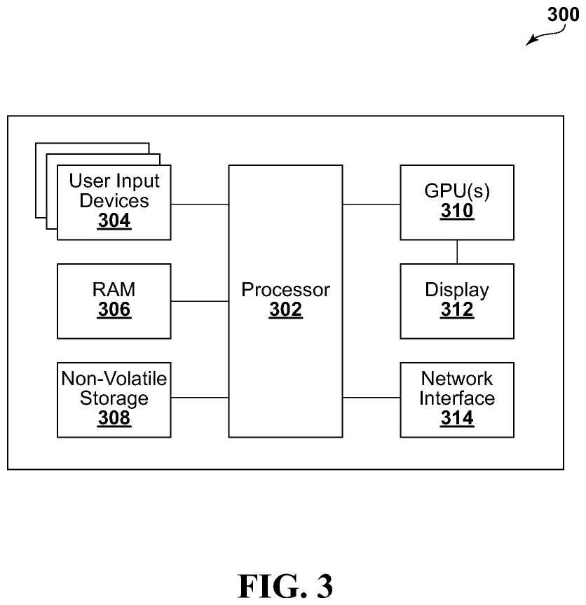

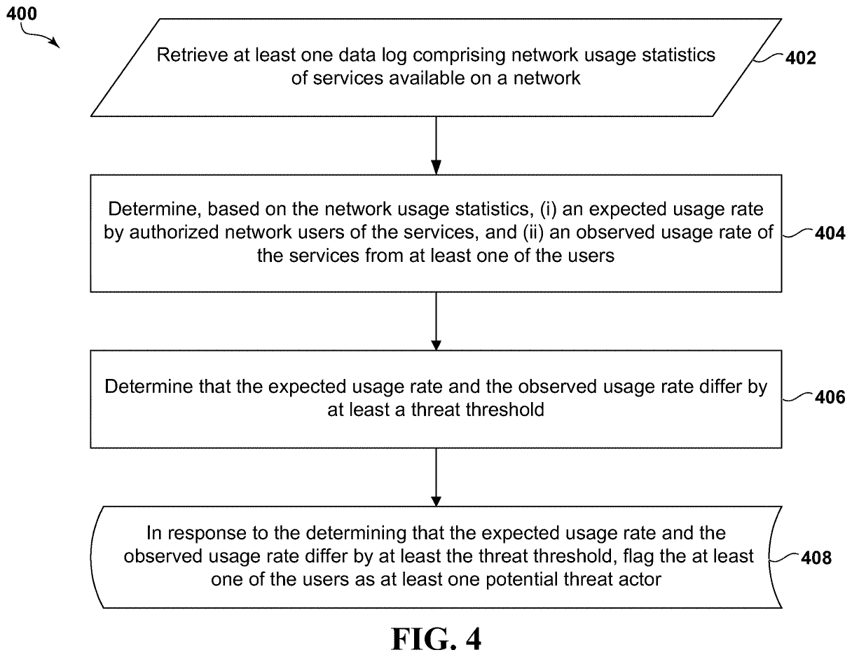

Referring now to FIG. 3, there is depicted an example embodiment of a computing device 300 that may act as the client 102, each of the servers of the server cluster 108 (including the KDC 202 and service server 204), the SIEM system 106, and a server acting as the system 100 for threat actor detection that comprises part of the data lake 104. The computing device 300 comprises a processor 302 that controls the computing device's 300 overall operation. The processor 302 is communicatively coupled to and controls several subsystems. These subsystems comprise user input devices 304, which may comprise, for example, any one or more of a keyboard, mouse, touch screen, voice control; random access memory (“RAM”) 306, which stores computer program code for execution at runtime by the processor 302; non-volatile storage 308, which stores the computer program code executed by the RAM 306 at runtime; at least one graphical processing unit (each a “GPU”) 310, which is communicatively coupled to and controls a display 312; and a network interface 314, which facilitates network communications with other computing devices on the network 112. The non-volatile storage 308 has stored on it computer program code that is loaded into the RAM 306 at runtime and that is executable by the processor 302. In respect of the computing device 300 used as the system 100 for network threat actor detection, the computer program code executed by the processor 302 causes the computing device 300 to implement a method for network threat actor detection as is described in more detail in respect of FIG. 4 below. Additionally or alternatively, the method for network threat actor detection may be performed on multiple computing devices using distributed computing.

The embodiments described herein are directed at methods, systems, and techniques for network threat actor detection, such as when a threat actor is attempting to gain unauthorized network access via Kerberoasting. On average, a threat actor seeking to harvest password hashes through Kerberoasting or an analogous type of network attack will not be familiar with the target environment, such as the network 112. Specifically, they are unlikely to know what the services in the target environment are for, and which users typically access them. The result is that when the threat actor seeks to enumerate services and exfiltrate the hashes, it is highly likely that the set of services queried will appear to be different from normal and benign users. For example, the services accessed by the threat actor may be uniformly randomly drawn from the complete set of services, which will look significantly different from a benign user going about business-as-usual activities. Similarly, the usage of the services by the threat actor can also differ from benign users. For example, a number of accesses or requests made by the threat actor to one or more services can differ from the number of accesses or requests made by a benign user to the same services. The usage distribution for the services by the threat actor may be different from a benign user. For example, the threat actor may utilize an unpopular service at an unusually high rate relative to a more popular service (i.e., access of the unpopular service being a large portion of the threat actor's service usage). The service usage by users can therefore be monitored to detect users having these usage/access anomalies and flagging these users as potential threat actors. This monitoring solution can therefore quickly and automatically detect and flag threat users based on service access/usage, thereby enabling a cyber threat hunting team to quickly investigate any potential network attack activity, such as Kerberoasting, for escalation.

As described above and further herein, the present disclosure is directed to threat actor detection and can accordingly provide a specific, concrete technical improvement to network security infrastructure by automatically identifying potential threat actors attempting to compromise network authentication systems, such as those exploiting vulnerabilities in Kerberos™ single sign-on protocols through “Kerberoasting” attacks. Rather than merely applying an abstract mathematical formula to generic data, in at least some embodiments the present disclosure fundamentally improves the functioning of enterprise network security by retrieving service-specific audit logs (e.g., SNARE logs) from security information and event management systems, computationally deriving expected service usage distributions from historical network access patterns, and applying Bayesian probability analysis and/or Kullback-Leibler divergence calculations to detect statistically significant deviations between a user's observed service access behavior and the expected behavior of authorized network users. These are anomalies that are characteristic of threat actors who lack a priori knowledge of the target environment and therefore access services in patterns (such as uniformly random distributions and expected access distributions) that differ materially from legitimate users conducting ordinary business activities. This automated, real-time comparison against dynamically computed threat thresholds enables the system to flag potential intrusions, store threat actor identification data in non-volatile storage, and restrict access for the potential threat actors, thereby providing a practical application that reduces the network's vulnerability to credential harvesting attacks, reduces the time required to detect lateral movement and privilege escalation attempts, and enhances the overall integrity and security posture of the protected computing environment.

More particularly, at least some embodiments herein are directed at a method 400 for network threat actor detection as depicted in FIG. 4. The method 400 may be implemented as processor-executable computer program code and stored on the non-volatile storage 308 comprising part of the system 100 for threat actor detection comprising part of the data lake 104 of FIG. 1. At runtime, the processor 302 comprising part of the system 100 loads the computer program code into RAM 306 and executes it, thereby communicating with the other components of the network 112 via the network interface 314 and performing the method 400.

The method 400 begins at block 402, where the system 100 retrieves at least one data log comprising network usage statistics of services available on the network 112. In some embodiments, the system 100 monitors network traffic and usage for a plurality of services and logs accesses of and requests to the services by all users of the network 112. Each request to the services may be logged and stored in a database as the at least one data log. That is, the at least one data log can be generated as a part of service monitoring. In some embodiments, each entry can identify a particular service and a user accessing the service. Accordingly, the at least one data log can include or be used to determine information for the total number of distinct users on the network 112, the number of distinct users accessing each service, a number of requests/accesses (e.g., usage amount) made to each service, a total number of requests/accesses, etc. The generated data log can be directly processed by the system 100 at block 404 as they are generated, for example as a part of service monitoring for real-time threat actor detection. Alternatively, the data log may be stored and subsequently retrieved from the database for processing at block 404, for example at regular intervals or upon user request for scheduled and periodic threat actor detection.

In one embodiment, the at least one data log may be generated by the audit log agents 110 and comprise SNARE logs, for example; and the system 100 may retrieve the SNARE logs from the SIEM system 106, which in turn retrieves them from the server cluster 108. As described above, the SNARE logs comprise at least information related to how many users of the network 112 have attempted to access each of the various services available on the network 112 for a period of time.

In some embodiments, the retrieved data log includes historical usage data/rate (e.g., number of distinct users, number of requests, etc.) over the period of time, particularly a period of time immediately before retrieval, such as over the past week, past month, past year, etc. This time period can be specified by the user and adjusted as desired.

At block 404, the system 100 determines, based on the network usage statistics, (i) an expected usage rate by authorized network users of the services, and (ii) an observed usage rate of the services from at least one of the users. The observed usage rate of the services is in respect of at least one of the users over a period of time who are being assessed as at least one potential threat actor, respectively. The expected usage rate by authorized network users of the services is more generally determined over a group of users for a particular reference period, for example. As described further below, two example ways in which the expected usage rate may be determined is using 1) a Bayesian approach, or 2) an entropy-based approach. In the current embodiment, the expected usage rate can correspond to or be determined from the (historical) usage statistics in the data log for all of the users on the network 112, particularly over the period of time. The observed usage rate can correspond to or be determined from the usage statistics in the data log for the at least one of the users, particularly over the same period of time. In some embodiments, the system 100 can evaluate the usage statistics for each user to determine whether the user is a potential threat actor at block 406 and block 408.

At block 406, following determination of the expected and observed usage rates, the system 100 determines that the expected usage rate and the observed usage rate differ by at least a threat threshold. Setting the threat threshold involves balancing the desire for precision ([true positives]/[true positives+false positives]), representative generally of how many identified users are actual threat actors vs. recall ([true positives]/[true positives+false negatives]), representative generally of how many actual threat actors are identified.

In at least some embodiments, the determination at block 406 is performed using a Bayesian approach and/or an entropy-based approach, as described further herein. Based on the observed usage rate and the expected usage rate, the system 100 can determine an observed usage likelihood based on service usage by the assessed user and a reference usage likelihood for evaluating the observed usage likelihood and serving as a comparison basis for the observed usage likelihood. The observed and reference likelihood are used to calculate a threat value, which is then evaluated against the threat threshold to determine if the expected usage rate and the observed usage rate differ by at least the threat threshold. In the Bayesian approach, a Bayesian probability is calculated using the observed and reference likelihoods as the threat value, and compared to a threshold probability as the threat threshold. In the entropy-based approach, a Kullback-Leibler (KL) entropy or divergence is calculated using the observed and reference likelihoods as the threat value, and compared to a threshold entropy as the threat threshold.

And at block 408, in response to the determining that the expected usage rate and the observed usage rate differ by at least the threat threshold (e.g., the Bayesian probability and/or the KL entropy exceeding the respective threat threshold), the system 100 flags the at least one of the users as at least one potential threat actor. Flagging may comprise the system 100's processor 302 storing, in the non-volatile storage, a file identifying the at least one potential threat actor and associated metadata, such as the services they were trying to access and the associated expected and observed usage rates. In response to being flagged, the network 112 may automatically act to suspend, temporarily (e.g., until the at least one potential threat actor has been cleared through subsequent screening) or permanently, the at least one potential threat actor's network access, and/or refer the at least one potential threat actor to additional automated and/or manual threat analysis.

In some embodiments, the processing at blocks 404 and 406 can be performed for a plurality of different time periods using data logs for different time periods or different lengths of time periods to improve threat actor detection accuracy. For example, a user may only be flagged as a potential threat actor if their service usage differs by at least the threat threshold for a majority of the evaluated time periods.

While blocks 404 and 408 refer to at least one of the users being assessed as at least one potential threat actor, for simplicity of illustration the following description contemplates assessing only whether a single user is a potential threat actor. However, this may be done multiple times to assess whether each of multiple users is a potential threat actor. Additionally or alternatively, a group of one or more users may be concurrently assessed, and if that group collectively satisfies the threat threshold, all the users in that group may be identified as potential threat actors. Each of those users in the identified group may then be individually assessed using the method 400.

In some embodiments, the system 100 can determine, for each assessed user, whether the user belongs to a group or type of users. This is because service usage for different groups or types of users may differ. For example, a particular group of users may be more likely to access one or more services in comparison to another group of users. In response to determining that the user belongs to a group or a type, the retrieved data log at block 404 may correspond to usage statistics for users of the group or type rather than all users of the network 112. Accordingly, the subsequent processing at block 404 and block 406 would then be based on the expected usage rate of the group or type of users, which can more accurately reflect whether the observed usage rate is consistent with the expected usage rate for the group or type of users.

### Bayesian Approach

As mentioned above, one example way in which to determine expected usage statistics is to apply a Bayesian approach.

Namely, in embodiments applying the Bayesian approach, to assess one or more users, the system 100 applies Bayesian statistics to determine the likelihood that a set of services x={x₁, x₂, . . . , xₙ} offered by the server cluster 108 and accessed/used by the assessed user is a uniform random draw from the superset of services X available on the network 112. That is, in this embodiment, the observed usage rate includes a list of or identification of the services accessed by the assessed user.

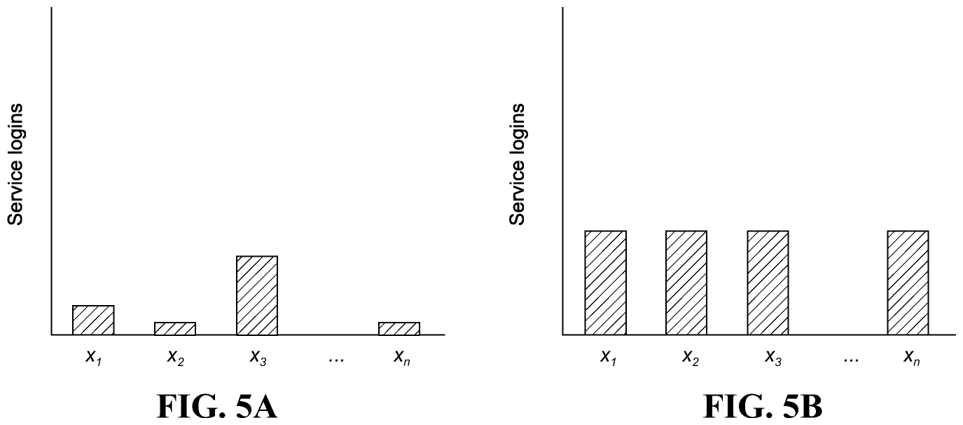

As mentioned above, it is unlikely that an actual service usage rate by authentic users of the network 112 would be uniform. Rather, an example actual service usage rate by authentic users corresponds to the service login data sampled over a period of time, as depicted in FIG. 5A, which is decidedly non-uniform. In contrast, FIG. 5B, which shows a uniform distribution of service logins over a corresponding period of time, is more likely to be the way a threat actor attempts to request services without a priori knowledge of how those services are authentically used. The difference the system 100 deems is permissible between the expected and observed usage rates corresponds to the threat threshold.

In one embodiment, to start, the empirical distribution of distinct users against services within the network 112 is constructed (i.e., a graph analogous to that of FIG. 5A). For each service, the total number of unique users that have requested SSO authentication, such as Kerberos™ authentication, in the historical (i.e., training) window is used. An example historical window is 90 days, although different training windows may be used. This is the global distribution G. The raw data used for the empirical distribution is retrieved by the system 100 from the SNARE logs, which comprise Kerberos™ request logs, at block 402 of the method 400. The expected and observed usage rates are determined as described below at block 404.

In the Bayesian approach, the observed usage likelihood is calculated based on the expected usage rate, which is the likelihood that any set of services x is drawn from this distribution is then determined in accordance with Equation (1):

$${L}_{G} = P ( x \vert G ) = \prod P ( {x}_{i} ) , \qquad ( 1 )$$

where P(xᵢ) is the probability of the i^{th} service being drawn and is dictated by G, and L_{G} is a first predicted probability corresponding to the observed usage likelihood.

In a first embodiment, the expected usage rate includes a number of distinct users for each service on the network 112, and a total number of distinct users on the network 112 accessing all of the services, which can be determined therefrom. The first predicted probability is calculated based on the number of distinct users. In particular, given the total number of distinct users on the network 112 accessing all of the services, the probability P(xᵢ) for a given user to access the service i is the number of distinct users accessing the service i, divided by the total number of distinct users. The first predicted probability is then the product of the probabilities P(xᵢ) for all of the services accessed by the assessed user. Accordingly, the observed usage likelihood represents how likely it is for a benign user to access the combination of services accessed by the assessed user based on standard user access patterns as dictated in the historical usage data (e.g., number of distinct users accessing each service), where the combination of services is given by the observed usage rate.

The reference usage likelihood is calculated based on the observed usage rate, which is the likelihood that the set x is drawn from the uniform random set of services U is given in Equation (2):

$${L}_{U} = P ( x \vert U ) = \prod P ( {x}_{j} ) = C , \qquad ( 2 )$$

where P(xⱼ) is the probability of the j^{th} service being drawn, and is equal to a constant C, which is dictated by the total number of services, and where Ly is a second predicted probability corresponding to the reference usage likelihood. That is, the reference usage likelihood is the likelihood of a threat actor without any a priori information as to service usage is a constant determined by the number of services being considered.

In the current embodiment, the second predicted probability is calculated based on a total number of services in the network 112. That is, under the assumption that the threat actor would access services randomly without any a priori information as to service usage, the probability P(xⱼ) of a given service j being accessed by a threat actor is simply 1 divided by the total number of services, corresponding to the constant C. The second predicted probability is then the product of the probabilities P(xⱼ) for all of the services accessed by the assessed user, which is C to the power of the number of accessed services. Accordingly, the reference usage likelihood represents how likely it is for a threat actor user to access the combination of services accessed by the assessed user assuming random access, where the combination of services is given by the observed usage rate.

Using Bayes' Theorem, the posterior likelihood that U is the underlying distribution from which x was sampled is given by Equation (3):

$$P ( U \vert x ) = \frac{P ( x \vert U ) P ( U )}{P ( x \vert U ) P ( U ) + P ( x \vert G ) P ( G )} . \qquad ( 3 )$$

Here, P(U|x) represents the Bayesian probability and returns a probability value between 0 and 1, representing the probability of the assessed user being a threat actor. As the first and second predicted probabilities represent the probability of the assessed user being a benign user (showing normal service usage pattern) and a threat actor (showing random usage pattern), respectively, the Bayesian probability estimates which of the two events (e.g., benign user vs threat actor) is more likely.

To determine the Bayesian probability, prior probabilities P(U) and P(G) are used. P(U) represents the probability of any given user being a threat actor (e.g., U being the event that a given user is a threat actor) and P(G) represents the probability of any given user being a benign user (e.g., G being the event that a given user is a benign user). These prior probabilities can be determined empirically, for example based on available threat actor data.

In the simple case where no assumptions are made about the prior likelihoods on U and G and P(U)=P(G)=0.5, then Equation (3) simplifies to the ratio of likelihoods as given in Equation (4):

$$P ( U \vert x ) = \frac{{L}_{U}}{{L}_{U} + {L}_{G}} . \qquad ( 4 )$$

Accordingly, in situations where P(U)=P(G)=0.5, the Bayesian probability that the user is a threat actor is purely based on the relative difference between the observed and reference usage likelihoods.

However, as discussed above and in contrast to the scenario where P(U)=P(G)=0.5, in practice it is very unlikely for a benign user to perform a uniform random search over services, so in general P(U)<<P(G). The values of the prior probabilities P(U) and P(G) or a ratio between the two probabilities can therefore be hyperparameters of the method 400. In some embodiments, the prior probabilities P(U) and P(G) can be adjusted for different groups of users or types of users.

In the current embodiment, the threat threshold can therefore be a threat probability corresponding to a confidence value. In this context, an example threat threshold is normalized to [0,1] and is compared to the output of Equation (4). This normalized threat threshold may be 0.9 or, in certain embodiments, at least 0.99. Note that any of the probability values can also be expressed as a percentage, with the threat threshold also expressed as a percentage between 0 and 100%. While the Bayesian probability is calculated as P(U|x), representing the probability of the assessed user being a threat actor, it can also be calculated as P(G|x), representing the probability of the assessed user being benign, with the threat threshold accordingly adjusted to be a small value, for example at most 0.1, or at most 0.01.

In a second embodiment, the expected usage rate includes a number of requests to or accesses of each service, and a total number of requests to or accesses of all of the services, which can be determined therefrom. The first predicted probability is then calculated based on usage of the services, for example. In particular, given the total number of requests made on the network 112 for all of the services, the probability P(xᵢ), representing an expected usage probability for a given user to access the service i is the number of requests for the service i, divided by the total number of requests. The first predicted probability is then the product of the probabilities P(xᵢ) for all of the services accessed by the assessed user. Accordingly, the observed usage likelihood in this embodiment also represents how likely it is for a benign user to access the combination of services accessed by the assessed user based on standard user access patterns. Here, the user access pattern is based on the number of requests made to each service, as given by the historical usage data. Note that under the random access assumption, the second predicted probability remains unchanged.

In some cases, the number of requests may be subject to frequency bias, where a small number of users may generate a large number of requests, particularly for services with limited distinct users. In such cases, the first embodiment may be preferable to avoid such biases.

The system 100 determines that the Bayesian probability P(U|x) is at least this threshold at block 406 (e.g., the probability of the assessed user being a threat actor must be at least 99%). Once the system 100 determines the difference satisfies that threshold, it flags the user corresponding to P(G) as a potential threat actor at block 408 as described above.

### Entropy-Based Approach

In an entropy-based approach, as in the Bayesian approach, the system 100 begins the method 400 at block 402 by retrieving at least one data log comprising network usage statistics of the services available on the network. As in the Bayesian approach, this may comprise retrieving the SNARE or other analogous audit log(s) from the SIEM system 106. As is the case with the Bayesian approach, the observed usage rate includes a list of or identification of the services accessed by the assessed user.

In respect of block 404 where the system 100 determines the expected and observed usage rates, there is no requirement in the entropy-based approach to assume that a threat actor will uniformly sample from the set of services available on the network 112. Rather, in an entropy-based approach, the reference usage likelihood is a baseline (or prior) discrete distribution Q(x). Q(x) is a first set of probabilities or distribution of probabilities, which can be determined from the expected usage rate.

In a first embodiment, and in the context of a Kerberos™ SSO in which the client 102 makes service ticket requests from the TGS, the reference usage likelihood is determined of ticket requests as a function of service during the period of time corresponding to the training window. In particular, the historical usage data includes a number of requests made to each service for all of the users on the network 112, and a total number of requests for all services, which can be determined therefrom. In particular, given the total number of requests, the probability Q(xᵢ), representing an expected usage probability for a given user to access the service i, is the number of requests for the service i, divided by the total number of requests. The reference usage likelihood is then the set of probabilities for usage of the services accessed by the assessed user for a benign user based on a distribution of user requests.

In a second embodiment, the historical usage data includes a distinct number of users for each service on the network 112, and a total number of distinct users on the network 112, which can be determined therefrom. In particular, given the total number of distinct users, the probability Q(xᵢ), representing the expected usage probability for the given user to access the service i, is the number of distinct users for the service i, divided by the total number of users. The reference usage likelihood is then the set of probabilities for usage of the services accessed by the assessed user for a benign user based on a distribution of distinct users.

The observed sample for each user specifies a multinomial distribution P(x) which perfectly describes the data in accordance with Equation (5):

$$P ( x ) = \frac{n !}{{x}_{1} ! … {x}_{n} !} {p}_{1}^{{x}_{1}} … {p}_{k}^{{x}_{k}} , \qquad ( 5 )$$

where Σpᵢ=1 and Σxᵢ=n, which is the total number of services.

At block 404, P(x) accordingly corresponds to the observed usage rate, while Q(x) corresponds to the expected usage rate, as described above. In particular, P(x) can be a second set of probabilities or distribution of probabilities, which can be determined from the observed usage rate.

In the first embodiment, the historical usage data includes a number of requests made to each service by the assessed user, and a total number of requests by the assessed user, which can be determined therefrom. In particular, given the total number of requests, the probability P(xᵢ), representing an observed usage probability for the assessed user to access the service i, is the number of requests made by the user for the service i, divided by the total number of requests made by the user. The observed usage likelihood is then the set of probabilities for usage of the services by the assessed user based on the number of user requests.

In the second embodiment, given the total number of requests, the probability P(xᵢ), representing an observed usage probability for the assessed user to access the service i, is 1 if the user accessed service i, and 0 otherwise. The observed usage likelihood is then the set of probabilities for usage of the services by the assessed user, based on the access of services by the user.

The relative entropy can then be determined in Equation (6), as given by the Kullback-Leibler (KL) divergence:

$${D}_{KL} ( P ‖ Q ) = \sum P ( {x}_{i} ) log \frac{P ( {x}_{i} )}{Q ( {x}_{i} )} . \qquad ( 6 )$$

Equation (6) therefore calculates a Kullback-Leibler entropy value. Heuristically, this serves to compare the information content between the two distributions, corresponding to the reference and observed usage likelihoods, where P(xᵢ) and Q(xᵢ) represent corresponding probabilities from the reference and observed usage likelihood probability sets. As KL divergence measures frequency distributions, the first embodiment may be preferable in the entropy-based approach.

A large relative entropy between P and Q indicates that a user's observed usage rate of services does not follow the baseline distribution (i.e., the expected usage rate of services) as represented in the reference usage likelihood. This entropy score is used to evaluate users at block 406 and an entropy value that exceeds the threat threshold can be used to identify the corresponding user as a potential threat actor at block 408. Accordingly, the threat threshold in the Entropy-based approach is a threshold entropy value.

In other words, analogous to how the threat threshold for the Bayesian approach is compared to the output of Equation (4), the threat threshold for the entropy-based approach is compared to the output of Equation (6). The threat threshold may be compared to the raw output of Equation (6); alternatively, the output of Equation (6) may be normalized to [0,1], in which case an example threat threshold may be greater than 0.9. Accordingly, when the system determines D_{KL}(P∥Q) exceeds that threshold at block 406, it then flags the user corresponding to that P as a potential threat actor. Analogous to the Bayesian approach, D_{KL}(Q∥P) may be calculated instead, with the threat threshold adjusted accordingly, for example to be less than 0.1.

While the foregoing describes the Bayesian and entropy-based approaches separately, in at least some embodiments they may be used in combination to improve method fidelity. For example, blocks 402-406 may be applied in respect of both approaches, and then the user may be flagged at block 408 only if the threat threshold is satisfied in respect of both approaches.

In both the Bayesian and entropy-based approaches described above, the expected usage rate is agnostic of the user in question who has queried the services and who is being considered as a potential threat actor. In at least some embodiments, different groups of users will have different expected usage rates, as described above. For example, a user who is associated with one peer group (e.g., management) may have a different service profile (e.g., personnel-related services) than a user who is associated with another peer group (e.g., technical development) that may preferentially use other types of services (e.g., code-related services). To account for this, in at least some embodiments the method 400 may also consider the peer group of the user. A peer group may also be, for example, all users belonging to the same line of business (LOB). Doing so in respect of the Bayesian approach replaces the global distribution G in Equations (1)-(4) with another distribution G* tailored to the user's particular peer group. Similarly, in respect of the entropy-based approach, the reference distribution Q(x) can be grown from a peer-group subset of the global data (e.g., the LOB).

Each of the processor 302 and GPU 310 may be one or more processors or microprocessors, which are examples of suitable processing units. Suitable processing units may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a file” or “the file” does not exclude embodiments in which multiple files are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means A, B, C; A and B; A and C; B and C; and A, B, and C.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. The term “or” is generally employed in its sense including “and/or” unless the content clearly dictates otherwise.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A network threat actor detection method comprising:
(a) retrieving at least one data log comprising network usage statistics of services available on a network;
(b) determining, based on the network usage statistics, (i) an expected usage rate by authorized network users of the services, and (ii) an observed usage rate of the services from at least one of the users;
(c) determining that the expected usage rate and the observed usage rate differ by at least a threat threshold; and
(d) in response to the determining that the expected usage rate and the observed usage rate differ by at least the threat threshold, flagging the at least one of the users as at least one potential threat actor.

2. The method of claim 1,
(a) wherein the expected usage rate is a historical usage rate of the services for all users over a time period determined from the network usage statistics; and
(b) wherein the observed usage rate comprises at least one service used by the at least one of the users from the services.

3. The method of claim 2, wherein the determining that the expected usage rate and the observed usage rate differ by at least the threat threshold comprises: determining an observed usage likelihood based on the observed usage rate and a reference usage likelihood for evaluating the observed usage likelihood to determine that the at least one of the users is the at least one potential threat actor.

4. The method of claim 3, wherein the determining that the expected usage rate and the observed usage rate differ by at least the threat threshold comprises:
(a) determining a Bayesian probability for the at least one service being used by a threat actor based on the observed usage likelihood and the reference usage likelihood; and
(b) determining that the expected usage rate and the observed usage rate differ by at least the threat threshold by comparing the Bayesian probability to a threshold probability.

5. The method of claim 4, wherein the historical usage rate comprises a number of distinct users for each of the services.

6. The method of claim 5,
(a) wherein the observed usage likelihood is a first predicted probability, calculated as a product of expected usage probabilities for the at least one service, each expected usage probability corresponding to the number of distinct users for a respective service and a total number of distinct users; and
(b) wherein the reference usage likelihood is a second predicted probability, calculated as a product of threat actor usage probabilities for the at least one service, each threat actor usage probability corresponding to a uniform probability across the services.

7. The method of claim 4,
(a) wherein the observed usage likelihood is a first predicted probability, calculated as a product of expected usage probabilities for the at least one service, each expected usage probability corresponding to a number of requests made by all of the users for a respective service and a total number of requests made by all of the users for the services; and
(b) wherein the reference usage likelihood is a second predicted probability, calculated as a product of threat actor usage probabilities for the at least one service, each threat actor usage probability corresponding to a uniform probability across the services.

8. The method of claim 4, wherein the determining of the Bayesian probability is further based on a first prior probability of the services being used by a benign user and a second prior probability of the services being used by the threat actor.

9. The method of claim 8, wherein the first and second prior probabilities or a ratio thereof are tunable hyperparameters.

10. The method of claim 8, wherein the first and second prior probabilities vary based on a type of the at least one of the users or a group to which the at least one of the users belongs.

11. The method of claim 3, wherein the determining of the threat threshold comprises:
(a) determining a Kullback-Leibler entropy value for the at least one service being used by a threat actor based on the observed usage likelihood and the reference usage likelihood; and
(b) determining that the expected usage rate and the observed usage rate differ by at least the threat threshold by comparing the Kullback-Leibler entropy value to a threshold entropy value.

12. The method of claim 11,
(a) wherein the historical usage rate comprises a number of requests made by all of the users for each of the services; and
(b) wherein the observed usage rate comprises a number of requests made by the at least one of the users for each of the at least one service.

13. The method of claim 12,
(a) wherein the observed usage likelihood is a first set of usage distributions for usage of the at least one service by the at least one of the users; and
(b) wherein the reference usage likelihood is a second set of usage distributions for usage of the at least one service by all of the users.

14. The method of claim 13,
(a) wherein each probability in the first set of usage distributions corresponds to the number of requests made by the at least one of the users for a respective service and a total number of requests made by the at least one of the users; and
(b) wherein each probability in the second set of usage distributions corresponds to the number of requests made by all of the users and a total number of requests made by all of the users.

15. The method of claim 1,
(a) wherein the at least one of the users belongs to a group of users; and
(b) wherein the expected usage rate is a historical usage rate of a selection of the services for the group of users over the time period determined from the network usage statistics.

16. The method of claim 1, wherein the at least one data log comprises at least one audit log generated by at least one server providing the services.

17. The method of claim 1, wherein the flagging comprises storing on non-volatile storage a file identifying the at least one of the users as the at least one potential threat actor.

18. The method of claim 1, further comprising: preventing the at least one of the users from accessing the services.

19. A network threat actor detection system comprising at least one processing unit configured to:
(a) retrieve at least one data log comprising network usage statistics of services available on a network;
(b) determine, based on the network usage statistics, (i) an expected usage rate by authorized network users of the services, and (ii) an observed usage rate of the services from at least one of the users;
(c) determine whether the expected usage rate and the observed usage rate differ by at least a threat threshold; and
(d) when the expected usage rate and the observed usage rate are determined to differ by at least the threat threshold, flag the at least one of the users as at least one potential threat actor.

20. A non-transitory computer-readable medium having stored thereon computer program code that is executable by at least one processor and that, when executed by the at least one processor, causes the at least one processor to perform a network threat actor detection method comprising:
(a) retrieving at least one data log comprising network usage statistics of services available on a network;
(b) determining, based on the network usage statistics, (i) an expected usage rate by authorized network users of the services, and (ii) an observed usage rate of the services from at least one of the users;
(c) determining whether the expected usage rate and the observed usage rate differ by at least a threat threshold; and
(d) when the expected usage rate and the observed usage rate are determined to differ by at least the threat threshold, flagging the at least one of the users as at least one potential threat actor.
